(19) United States
(12) Patent Application Publication
(10) Pub. No.: US 2014/0109237 A1
(43) Pub. Date: Apr. 17, 2014

(54) APPLICATION MODES DETERMINED FROM PREVIOUS AND CURRENT STATES OF A LICENSE

(71) Applicant: MICROSOFT CORPORATION, Redmond, WA (US)

(72) Inventors: Steven M. Novick, Seattle, WA (US); Karvell Li, Bellevue, WA (US)

(73) Assignee: MICROSOFT CORPORATION, Redmond, WA (US)

(21) Appl. No.: 13/653,614

(22) Filed: Oct. 17, 2012

(51) Int. Cl. G06F 21/20

(52) U.S. Cl. 726/27

(57) ABSTRACT

Disclosed herein are systems, methods, and software for facilitating application licensing. In at least one implementation, a previous state of a license for an application is identified upon launching or otherwise engaging the application. In addition, a current state of the license for the application is identified. A determination is made with respect to in which mode to present the application based on the previous state and the current state. Presentation of the application in the determined mode may then be initiated.

### TECHNICAL FIELD

Aspects of the disclosure are related to computer hardware and software technology, and in particular, to software licensing technology.

### TECHNICAL BACKGROUND

A variety of licensing models and technologies exist to prevent the unauthorized use and distribution of software products. For example, some solutions involve product keys or tokens to authenticate software, as well as usernames and passwords to govern access. Some solutions authenticate a software product during installation. Other solutions call for authentication each time an application is launched, while yet other solutions may employ variations or combinations thereof or even different mechanisms entirely.

In many circumstances, licensing information that is stored locally, remotely, or elsewhere, is typically referenced to determine the state of a software license. The license information may indicate, for example, that a license is current, expired, unpaid, or the like. The subject application can then be presented, or in some cases not presented at all, based on the state of the license. For example, a limited version of an application may be presented upon detection of an expired license and a user may be prompted to visit a website or application store to purchase or update the license.

Balancing the effectiveness of a given license enforcement paradigm with the quality of a user experience is just one challenge faced by many software developers. In general, the more rigid or strict an enforcement paradigm, the greater the prevention afforded to a given software product against unauthorized use and distribution. However, such license enforcement may also lead to sub-optimal user experiences.

### OVERVIEW

Provided herein are systems, methods, and software for facilitating application licensing. In at least one implementation, a previous state of a license for an application is identified upon launching or otherwise engaging the application. In addition, a current state of the license for the application is identified. A determination is made with respect to in which mode to present the application based on the previous state and the current state. Presentation of the application in the determined mode may then be initiated.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an application environment in an implementation.

FIG. 2 illustrates a license process in an implementation.

FIG. 3 illustrates a computing system in an implementation.

FIG. 4 illustrates an operational scenario involving a communication device in an implementation.

FIG. 5 further illustrates the communication device in an implementation.

FIG. 6 illustrates an operational scenario in an implementation.

FIG. 7 illustrates an operational scenario in an implementation.

FIG. 8 illustrates an operational scenario in an implementation.

FIG. 9 illustrates an operational scenario in an implementation.

### TECHNICAL DISCLOSURE

Implementations described herein provide for improved application licensing whereby application modes are determined based on at least both the previous state of a license for an application or a suite of applications and a current state of the license for the application or suite of applications. By considering the previous and current states of a license, licensing mechanisms can be accommodated while still allowing for flexible application usage.

For example, a user may be allowed to continue using an application even if the current state of a license is expired. This may occur when the previous state of the license is paid or otherwise authorized. In another example, a user may be allowed to continue using an application even if a previous state of the license is recently expired. In such a case, such use is allowed while the current state of the license is checked. In some cases, the current state may be reported as paid, in which case full application use may continue. In other cases, the current state may be reported as unpaid, in which case full application use may also continue. However, other steps may also occur, such as alerting the user to the recent expiration of the license and providing a mechanism so that the license may be purchased or otherwise authorized.

In some implementations, upon determining the current state of a license, the previous state of the license may be updated, resulting in an updated previous state. Thus, during a subsequent launch of the application, it is the updated previous state that is examined, along with the current state of the license.

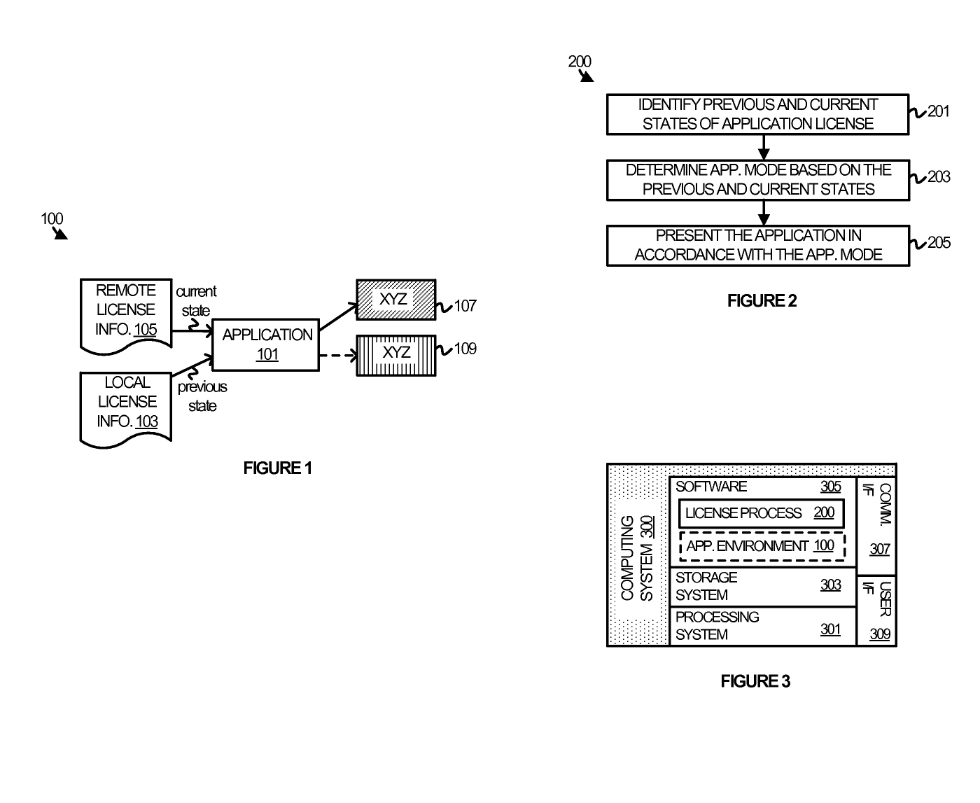

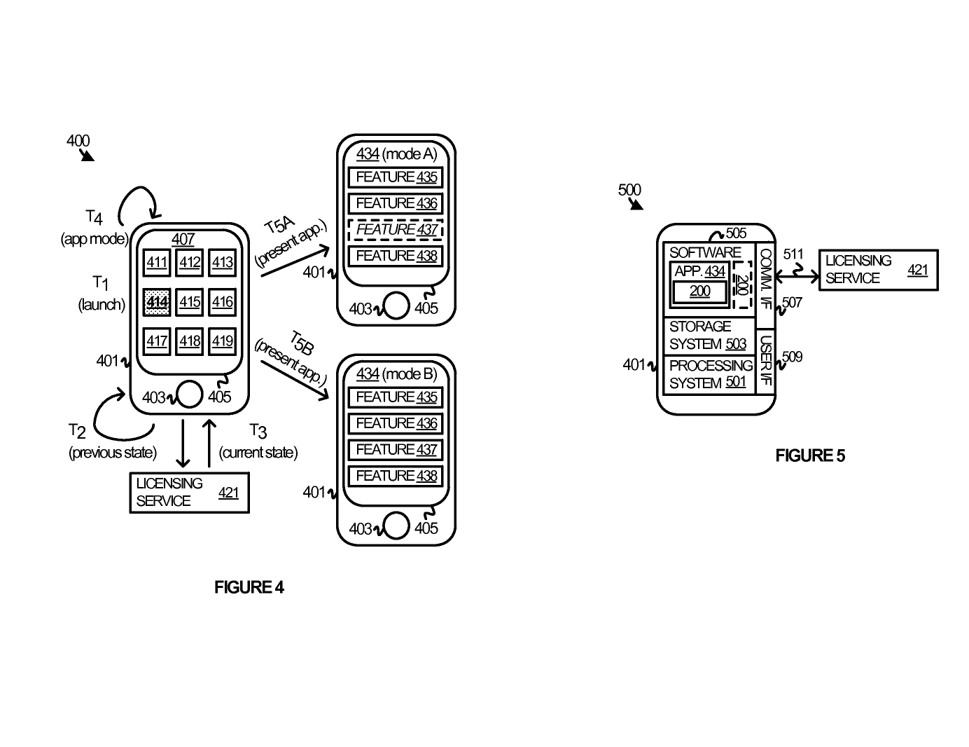

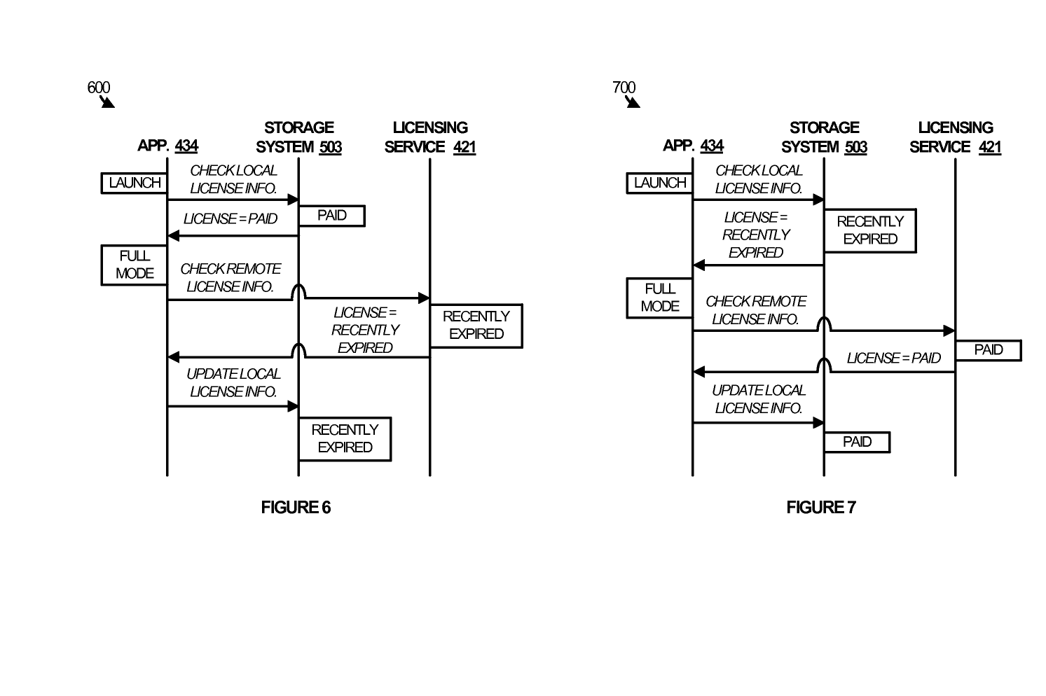

Referring to the drawings, FIG. 1 illustrates an application environment in which a license process may be employed that authorizes application use based on the previous and current states of a license. FIG. 2 illustrates the license process, while FIG. 3 illustrates a computing system on which the license process and the application environment may be implemented. FIG. 4 illustrates the operations of a communication device, itself further illustrated in FIG. 5. FIGS. 6-9 illustrate several operational scenarios involving the communication device in FIGS. 4-5.

Turning now to FIG. 1, application environment 100 is illustrated in an implementation. Application environment 100 includes application 101, local license information 103, remote license information 105, presentation mode 107, and presentation mode 109. Application 101 may be any software application or product subject to a license, terms, or other restriction or guidelines limiting its use and distribution. Examples of application 101 include productivity applications, communication applications, collaboration applications, gaming applications, enterprise applications, and mobile applications, as well as any combination or variation thereof, as well as another other type of application subject to at least some restrictions on its use and distribution.

Local license information 103 may be any information from which a previous state of a license for application 101 may be identified, while remote license information 105 may be any information from which a current state of the license for application 101 may be identified. Local license information 103 and remote license information 105 can also be understood in terms of relative latency. Local license information 103 may be stored in such a manner or location relative to remote license information that less latency is involved when identifying the previous state of the license compared to the current state of the license.

For example, local license information 103 may be any information stored locally with respect to application 101, of which at least a portion may include data representative of a previous state of a license for application 101. Remote license information 105 may be any information stored remotely with respect to application 101, of which at least a portion may include data representative of a current state of the license for application 101. Briefly referring to FIG. 3 merely for illustrative purposes, local license information 103 may be stored on storage system 303, while remote license information 105 may be stored on some other system remote from computing system 300, accessible via communication interface 307.

In another example, local license information 103 may be stored remotely from application 101, while remote license information 105 may also be stored remotely from application 101. In such an example, the latency involved in determining the previous state of the license may still be less than the latency involved in identifying the current state of the license. This may occur in a number of scenarios, such as when local license information 103 is stored in a location proximate to application 101 relative to the location where remote license information 105 may reside.

Presentation mode 107 is representative of one mode in which application 101 may be presented via a user interface, such as a display, depending upon both the previous state and the current state of the license for application 101. Presentation mode 109 is also representative of another mode in which application 101 may be presented based on both the previous state and the current state of the license for application 101. The fill style of presentation mode 107 differs from the fill style of presentation mode 109 to demonstrate that various application modes are possible based on the various possible combinations of previous and current states for the license. For example, one state combination may correspond to one particular application mode, while another state combination may correspond to another, different application mode. In which mode an application is presented may influence which features, services, tools and other aspects of the application are available.

FIG. 2 illustrates license process 200 that may be employed in an implementation to facilitate application licensing. The following discussion of license process 200 will proceed with reference application environment 100 in order to illustrate its operations. In operation, in response to launching or engaging application 101, a previous state of a license for application 101 and a current state of the license for application 101 are identified (step 201). Application 101 may be launched or otherwise engaged in a variety of ways. For example, application 101 may be launched in response to a user input or command, such as a touch, click, or gesture, indicative of a desire to engage with application 101. In another example, application 101 may already be open or running, or at least already launched, and a user may navigate to a view of application 101. In yet another example, another application or software component may make a call to application 101 or otherwise initiate an action that engages application 101.

A mode in which application 101 may be presented is then determined based on the previous state of the license and the current state of the license for application 101 (step 203). As mentioned, a number of state combinations may be possible. The various combinations may correspond to various application modes. For example, some combinations may correspond to one mode, while other combinations may correspond to another mode. In yet another example, each combination may correspond to a unique application mode. Note that a variety of combinations, application modes, and the correspondence thereof are possible and may be considered within the scope of the present disclosure.

Application 101 can then be presented in accordance with the mode determined above (step 205). Each mode may differ relative to other modes in a variety of ways. For example, some modes may include features, services, or tools not found or not available in other modes. In another example, the features, service, or tools available in one mode may be the same or similar to those in another mode, but their availability may be limited with respect to time, frequency of use, or some other suitable limiting factor. Note that a variety of differences between modes are possible and may be considered within the scope of the present disclosure.

While license process 200 generally refers to identifying the previous and current state of a license, determining an application mode, and presenting an application in accordance with the mode, variations of license process 200 are possible. For example, a variation of license process 200 may involve initiating each of the aforementioned steps, in addition to or in place of actually performing each of the aforementioned steps. For example, a variation of license process 200 may include some or all of initiating the identification of the previous and current states, initiating the determination of the application mode, and initiating the presentation of the application in accordance with the mode.

Computing system 300, referred to in FIG. 3, may be representative of any computing apparatus, system, or systems on which license process 200 or variations thereof may be suitably implemented. Optionally, computing system 300 may also be suitable for implementing all of or portions of application environment 100. Examples of computing system 300 include mobile computing devices, such as cell phones, tablet computers, laptop computers, notebook computers, and gaming devices, as well as any other type of mobile computing devices and any combination or variation thereof. Examples of computing system 300 also include desktop computers, server computers, and virtual machines, as well as any other type of computing system, variation, or combination thereof.

Computing system 300 includes processing system 301, storage system 303, software 305, communication interface 307, and user interface 309. Processing system 301 is operatively coupled with storage system 303, communication interface 307, and user interface 309. Processing system 301 loads and executes software 305 from storage system 303. When executed by computing system 300 in general, and processing system 301 in particular, software 305 directs computing system 300 to operate as described herein for license process 200 or variations thereof. Computing system 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variations thereof.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. In addition to storage media, in some implementations storage system 303 may also include communication media over which software 305 may be communicated. Storage system 303 may be implemented as a single storage device but may also be implemented across multiple storage devices or sub-systems co-located or distributed relative to each other. Storage system 303 may comprise additional elements, such as a controller, capable of communicating with processing system 301.

Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the storage media a propagated signal.

Software 305 may be implemented in program instructions and among other functions may, when executed by computing system 300 in general or processing system 301 in particular, direct computing system 300 or processing system 301 to identify the previous and current state of a license, determine an application mode based on the previous and current state of the license, and present an application in accordance with the determined mode. Software 305 may include additional processes, programs, or components, such as operating system software or other application software. Software 305 may also comprise firmware or some other form of machine-readable processing instructions executable by processing system 301.

In at least one implementation, the program instructions may include first program instructions that direct processing system 301 to determine a first state of a license for a software application based at least in part on local license information, second program instructions that direct processing system 301 to determine a second state of the license for the software application based at least in part on remote license information, and third program instructions that direct processing system 301 to determine an application mode in accordance with which to present the software application based on at least the first state of the license and the second state of the license.

In some implementations, the program instructions may include fourth program instructions that direct processing system 301 to update the previous state of the license for the application to an updated previous state based on the current state of the application. Responsive to a subsequent launch of the application, the fourth program instructions may direct processing system 301 identify the updated previous state of the license for the application and a subsequent current state, determine a subsequent application mode based on at least the updated previous state and the subsequent current state, and initiate presentation of the application in accordance with the subsequent application mode. In some scenarios, the fourth program instructions may also direct processing system 301 or other elements of computing system 300 to present the software application in the application mode.

In general, software 305 may, when loaded into processing system 301 and executed, transform computing system 300 overall from a general-purpose computing system into a special-purpose computing system customized to facilitate application licensing as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage.

For example, if the computer-storage media are implemented as semiconductor-based memory, software 305 may transform the physical state of the semiconductor memory when the program is encoded therein. For example, software 305 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 300 is generally intended to represent a computing system with which software 305 is deployed and executed in order to implement license process 200 (and variations thereof) and optionally all or portions of application environment 100. However, computing system 300 may also represent any computing system on which software 305 may be staged and from where software 305 may be distributed, transported, downloaded, or otherwise provided to yet another computing system for deployment and execution, or yet additional distribution.

Referring again to FIG. 1, through the operation of computing system 300 employing software 305, transformations may be performed with respect to application environment 100. As an example, application 101 could be considered transformed from one state to another when subject to license process 200 or variations thereof. In a first state, computing system 300 may render application 101 in presentation mode 107 based on the previous and current states of the license for application 101. Upon a change occurring with respect to either the previous state or current state, or both, computing system 300 may render application 101 in presentation mode 109.

Referring again to FIG. 3, communication interface 307 may include communication connections and devices that allow for communication between computing system 300 and other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface 309 may include a mouse, a voice input device, a touch input device for receiving a gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface 309. The aforementioned user input devices are well known in the art and need not be discussed at length here. User interface 309 may also include associated user interface software executable by processing system 301 in support of the various user input and output devices discussed above. Separately or in conjunction with each other and other hardware and software elements, the user interface software and devices may provide a graphical user interface, a natural user interface, or any other kind of user interface.

FIG. 4 illustrates operational scenario 400 in an implementation involving the application of license process 200 by communication device 401. Communication device 401 includes control element 403 and display system 405. Communication device 401 includes other components described in more detail with respect to FIG. 5, including processing system 501, storage system 503, software 505, communication interface 507, and user interface 509. Software 505 includes application 434, which itself includes license process 200. License process 200 may optionally be implemented separately from application 434.

In operation, in conjunction with user interface 509, processing system 501 loads and executes portions of software 505, such as operating system elements, to render application menu 407 for display by display system 405. Examples of operating systems include Windows®, iOS, and Android, as well as any other suitable operating system. Application menu 407 includes application icons 411-419. Application icons 411-419 each correspond to applications installed on communication device 401. Upon selection of one application icons 411-419, a corresponding application is launched. Note than an application may be selected from within other views, such as an application hub.

In operational scenario 400, application icon 414 is selected at time T1. For exemplary purposes, it is assumed that application icon 414 corresponds to application 434. At time T2, communication device 401 identifies the previous state of a license for application 434. This may be accomplished be referencing locally stored license information stored internally to communication device 401. At time T3, communication device 401 communicates with licensing service 421 to identify the current state of the license for application 434. Licensing service 421 may perform a number of functions, such as obtaining provisioning data from various sources, obtaining product keys, providing keyless authorization, and managing user to machine relationships.

Having identified the previous and current states of the license, at time T4 an application mode according to which application 434 may be presented is identified. As discussed above, a number of combinations of previous and current license states may be possible, and thus a number of application modes may also be possible. To illustrate the variations possible between different application modes, two exemplary application presentations are presented.

First, at time TSA, application 434 is presented in accordance with mode A. In this example, application 434 is presented with four features 435, 436, 437, and 438. However, features 437 is illustrates as disabled. In contrast, at time TSB, all four features are illustrates as enabled, include feature 437. This is intended to demonstrate just one way in which application modes may differ at a feature level. Other ways in which application modes may differ are possible and may be considered within the scope of this disclosure.

FIGS. 6-9 illustrate several operational sequences that further describe the application of license process 200 by communication device 401. Referring to FIG. 6, in sequence 600 application 434 checks local license information stored on storage system 503 to determine the previous state of the license for application 434. In this sequence, it is assumed for illustrative purposes that the previous state is paid. Because the previous state of the license is paid, application 434 may be presented in a full mode.

In the meantime, application 434 communicates with licensing service 421 to determine the current state of the license for application 434. In this sequence, the current state is recently expired. Upon determining the current state of the license, application 434 updates the previous state of the license from paid to recently expired. In this way, the next time application 434 is launched, the previous state will accurately reflect the recent expiration of the license.

In FIG. 7, sequence 700 is presented whereby the starting value of the previous state of the license is recently expired. This may be determined upon launching application 434 and examining licensing information stored on storage system 503. Even though the license is expired, application 434 may be presented in full mode because the previous state is merely recently expired.

Application 434 also communicates with licensing service 421 to check the current state of the license as maintained by licensing service 421. In this illustration, the current state is paid. Application 434 updates the previous state of the license accordingly, from recently expired to paid. In this way, the next time application 434 is launched, the previous state will accurately reflect that the license is no longer recently expired, but paid.

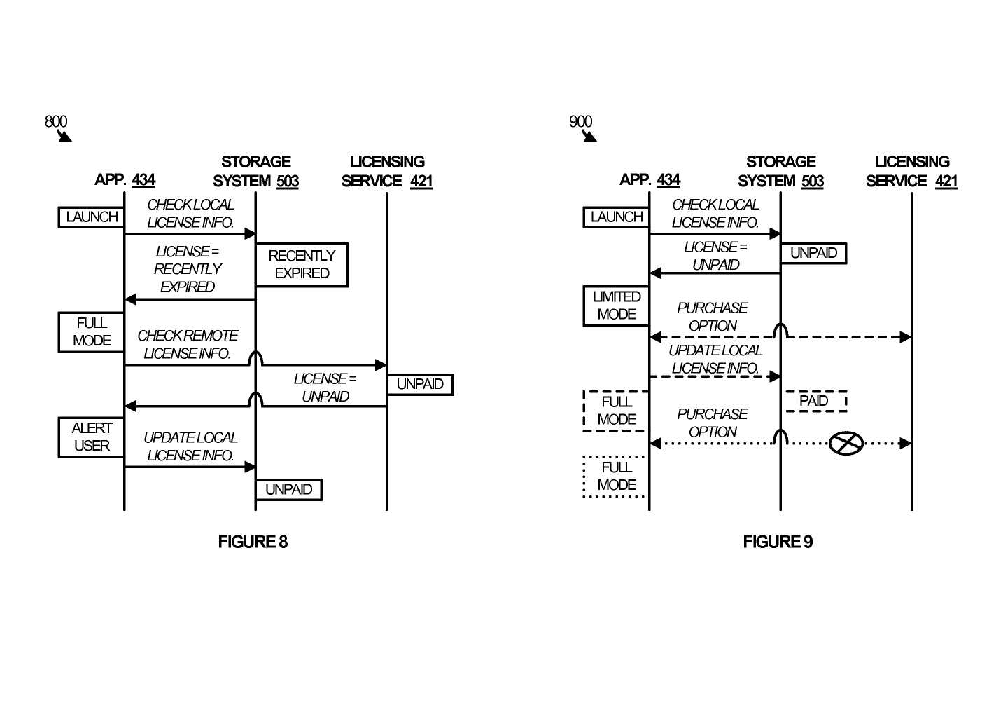

Referring to FIG. 8, sequence 800 begins with the launch of application 434, at which time local license information stored on storage system 503 is checked for the previous state of the license. In this sequence, it is assumed for illustrative purposes that the previous state is recently expired. Even though the license is expired, application 434 may be presented in full mode because the previous state is merely recently expired. Next, remote license information maintained by licensing service 421 is obtained to determine the current state of the license for application 434.

In this sequence it is assumed for illustrative purposes that current state is unpaid. In circumstances where the current state of the license is unpaid, a number of responses may be triggered. In this illustration, an alert is provided to a user that the license is in an unpaid state. It may be possible for the user to take various actions, such as purchasing the license. In any case, the previous state of the license stored on storage system 503 is updated to unpaid to reflect that the license is no longer in a recently expired state.

In FIG. 9, sequence 900 also begins when application 434 is launched. Upon launching application 434, local license information stored on storage system 503 is checked to determine the previous state of the license for application 434. In this sequence, it is assumed for illustrative purposes that the previous state is unpaid. Because the previous state is unpaid, application 434 may be presented in a limited mode. For example, the limited mode may include less features, tools, or other aspects relative to those in the full mode. In some scenarios the limited mode may be considered a free or trial mode.

Sequence 900 also includes a purchase option that may be carried out to qualify application 434 for presentation in the full mode. Application 434 or some other utility may communicate with licensing service 421 to purchase or otherwise update the license. For example, a user could purchase application 434 outright via an application store, sign up for subscription based usage, or potentially sign-in using an identity that is associated with a valid subscription, a volume license, or other licensing scheme. Note that a purchase option is merely exemplary of many different ways in which application access may be authorized.

In this scenario, the local license information stored on storage system 503 may be updated to reflect that the state of the license is now paid. In this manner, the next time application 434 is launched the previous state of the license will accurately reflect that the license has been paid for, allowing for application 434 to be presented in full mode.

In another scenario, an attempted purchase of the license may not be possible. For example, it may not be possible for application 434 to communicate with licensing service 421 due to the inability of communication device 401 to communicate with licensing service 421. In such a scenario, an exception may be allowed such that application 434 can be presented in full mode. In this manner, presenting application 434 in the limited mode may be avoided at least temporarily.

In some situations, the duration for which application 434 is unable to communicate with licensing service 421 may be tracked. This duration may be compared to duration criteria to determine whether or not an exception may be allowed such that application 434 can be presented in full mode. For example, the duration may be compared to a threshold amount of time. If the duration does not exceed the threshold amount of time, then application 434 can be presented in full mode. If the duration meets or exceeds the threshold amount of time, then it may be that the exception is not allowed and application 434 proceeds to be presented in a limited mode.

In some implementations, an application may be one of several applications in a suite of applications. The previous state of a license may be accessible based on a developer profile associated with the application. In this manner, local license information may be accessed on behalf of any of the multiple applications in the suite. For example, a license may be obtained for the suite of applications and license information stored indicative of the previous state of the license. Remote license information may be stored by an online licensing service or some other remote data store. The remote license information may indicate the current state of the license for the suite and may be accessible based on a variety of information, such as the developer of the application, a user identity, a license identity, or any other type of suitable identifying information.

Upon launching an application from the application suite, the local license information may be accessed based on a developer profile associated with the application. Thus, when another application from the suite is launched, the same local license information may be accessed. In fact, such a configuration allows access to license information for any application, regardless of whether or not it belongs to an application suite, to be governed based on the identity of or profile for a developer of the application.

In some implementations, the local license information may be stored in and retrieved from a data structure accessible based on an identity of a developer of the application indicated by the developer profile. To retrieve the local license information, an application may communicate a request to a utility application to access the data structure. One exemplary utility application is a keychain service application.

In various scenarios involving one such keychain service application or keychain utility, an application may communicate the previous state of the license to the keychain utility, such that the previous state of the license may be stored in a keychain data structure accessible based on the developer profile associated with the application. The application or another application associated with the same developer may also communicate with the keychain utility to access the previous state of the license.

Referring back to FIG. 5, communication device 401 may be representative of any computing apparatus, system, or systems on which application 434 and license process 200 or variations thereof may be suitably implemented. Examples of communication device 401 include mobile computing devices, such as cell phones, tablet computers, laptop computers, notebook computers, and gaming devices, as well as any other type of mobile computing devices and any combination or variation thereof. Note that the features and functionality of communication device 401 may apply as well to desktop computers, server computers, and virtual machines, as well as any other type of computing system, variation, or combination thereof.

Communication device 401 includes processing system 501, storage system 503, software 505, communication interface 507, and user interface 509. Processing system 501 is operatively coupled with storage system 503, communication interface 507, and user interface 509. Processing system 501 loads and executes software 505 from storage system 503. When executed by communication device 401 in general, and processing system 501 in particular, software 505 directs communication device 401 to operate as described herein for license process 200 or variations thereof. Communication device 401 may optionally include additional devices, features, or functionality not discussed here for purposes of brevity.

Referring still to FIG. 5, processing system 501 may comprise a microprocessor and other circuitry that retrieves and executes software 505 from storage system 503. Processing system 501 may be implemented within a single processing device but may also be distributed across multiple processing devices or sub-systems that cooperate in executing program instructions. Examples of processing system 501 include general purpose central processing units, application specific processors, and logic devices, as well as any other type of processing device, combinations, or variations thereof.

Storage system 503 may comprise any computer readable media or storage media readable by processing system 501 and capable of storing software 505. Storage system 503 may include volatile and nonvolatile, removable and non-removable media implemented in any method or technology for storage of information, such as computer readable instructions, data structures, program modules, or other data. Storage system 503 may be implemented as a single storage device but may also be implemented across multiple storage devices or sub-systems co-located or distributed relative to each other. Storage system 503 may comprise additional elements, such as a controller, capable of communicating with processing system 501. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the storage media a propagated signal.

Software 505 may be implemented in program instructions and among other functions may, when executed by communication device 401 in general or processing system 501 in particular, direct communication device 401 or processing system 501 to identify the previous and current state of a license, determine an application mode based on the previous and current state of the license, and present an application in accordance with the determined mode. Software 505 may include additional processes, programs, or components, such as operating system software or other application software. Software 505 may also comprise firmware or some other form of machine-readable processing instructions executable by processing system 501. In general, software 505 may, when loaded into processing system 501 and executed, transform communication device 401 overall from a general-purpose computing system into a special-purpose computing system customized to facilitate application licensing as described herein for each implementation.

Communication interface 507 may include communication connections and devices that allow for communication between communication device 401 and other computing systems (not shown) or services, such as licensing service 421, over a communication network or collection of networks (not shown). Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 509 may include a voice input device, a touch input device for receiving a gesture from a user, a motion input device for detecting non-touch gestures and other motions by a user, and other comparable input devices and associated processing elements capable of receiving user input from a user. Output devices such as display system 405, speakers, haptic devices, and other types of output devices may also be included in user interface 509. The aforementioned user input devices are well known in the art and need not be discussed at length here. User interface 509 may also include associated user interface software executable by processing system 501 in support of the various user input and output devices discussed above. Separately or in conjunction with each other and other hardware and software elements, the user interface software and devices may provide a graphical user interface, a natural user interface, or any other kind of user interface.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having stored thereon program instructions for facilitating application licensing that, when executed by a computing system, direct the computing system to at least:
responsive to a launch of an application, identify a previous state of a license for the application and a current state of the license for the application;
determine an application mode based at least in part on the previous state of the license and the current state of the license; and
initiate presentation of the application in accordance with the application mode.

2. The one or more computer readable storage media of claim 1 wherein the program instructions, when executed by the computing system, further direct the computing system to update the previous state of the license for the application to an updated previous state based at least in part on the current state of the application.

3. The one or more computer readable storage media of claim 2 wherein the program instructions, when executed by the computing system, further direct the computing system to, responsive to a subsequent launch of the application, identify the updated previous state of the license for the application and the current state, determine a subsequent application mode based at least in part on the updated previous state and the current state, and initiate presentation of the application in accordance with the subsequent application mode.

4. The one or more computer readable storage media of claim 3 wherein the previous state of the license comprises paid and the updated previous state comprises recently expired.

5. The one or more computer readable storage media of claim 3 wherein the previous state of the license comprises recently expired and the updated previous state comprises paid.

6. The one or more computer readable storage media of claim 3 wherein the previous state of the license comprises recently expired and the updated previous state comprises unpaid.

7. The one or more computer readable storage media of claim 1 wherein to identify the previous state of the license for the application, the program instructions direct the computing system to retrieve local license information comprising the previous state of the license, and wherein to identify the current state of the application, the program instructions direct the computing system to retrieve remote license information comprising the current state of the license.

8. A method for facilitating application licensing comprising:
responsive to initiating a current use of an application, determining a current state of a license for the application;
responsive to initiating the current use of the application, identifying a previous state of the license for the application determined during a previous use of the application;
determining an application mode based on at least the previous state of the license and the current state of the license; and
presenting the application in accordance with the application mode during the current use of the application.

9. The method of claim 8 further comprising initiating communication between a communication device and a licensing service remote from the communication device to obtain remote license information comprising the current state of the license and retrieving local license information comprising the previous state of the license.

10. The method of claim 9 further comprising processing the local license information to update the previous state of the license to an updated previous state based on the current state.

11. The method of claim 10 further comprises retrieving the local license information from a data structure accessible based on an identity of a developer of the application.

12. The method of claim 11 wherein the data structure comprises a keychain data structure.

13. The method of claim 8 wherein the application mode comprises one of at least a full mode and a limited mode.

14. The method of claim 8 wherein the previous state comprises one of at least paid, unpaid, and recently expired, and wherein the current state comprises one of at least paid, unpaid, and recently expired.

15. A computing apparatus comprising:
a storage system;
first program instructions stored on the storage system that, when executed by a processing system, direct the processing system to determine a first state of a license for a software application based at least in part on local license information;
second program instructions stored on the storage system that, when executed by the processing system, direct the processing system to determine a second state of the license for the software application based at least in part on remote license information; and
third program instructions stored on the storage system that, when executed by the processing system, direct the processing system to determine an application mode in accordance with which to present the software application based on at least the first state of the license and the second state of the license.

16. The computing apparatus of claim 15 wherein the software application comprises a productivity application including the first program instructions, the second program instructions, and the third program instructions.

17. The computing apparatus of claim 15 further comprising the processing system configured to execute the first program instructions, the second program instructions, and the third program instructions.

18. The computing apparatus of claim 17 further comprising a data structure stored on the storage system and accessible based on based on an identity of a developer of the application.

19. The computing apparatus of claim 18 wherein the data structure comprises a keychain data structure.

20. The computing apparatus of claim 15 wherein the first state comprises a previous state after a launch of the application and wherein the second state comprises a current state after the launch of the application, and wherein the computing apparatus further comprises:
fourth program instructions stored on the storage system that, when executed by the processing system, further direct the processing system to update the previous state of the license for the application to an updated previous state based on the current state of the application and, responsive to a subsequent launch of the application, identify the updated previous state of the license for the application and a subsequent current state, determine a subsequent application mode based on at least the updated previous state and the subsequent current state, and initiate presentation of the application in accordance with the subsequent application mode.
